(19) United States
(12) Patent Application Publication
(10) Pub. No.: US 2026/0148043 A1
(43) Pub. Date: May 28, 2026

(54) TRAINING LARGE LANGUAGE MODELS FOR PREDICTIVE MAINTENANCE

(71) Applicant: Cisco Technology, Inc., San Jose, CA (US)

(72) Inventors: Shaja Arul Selvamani, Union City, CA (US); Sachin Gupta, San Jose, CA (US); Shubha Pant, Portola Valley, CA (US)

(73) Assignee: Cisco Technology, Inc., San Jose, CA (US)

(21) Appl. No.: 18/956,161

(22) Filed: Nov. 22, 2024

(51) Int. Cl. G06N 3/0475; G06F 16/25

(52) U.S. Cl. CPC G06N 3/0475; G06F 16/258

(57) ABSTRACT

In one implementation, a device obtains log data from a monitored system. The device processes the log data using a rolling window to form log chunks. The device converts the log chunks into tokenized chunks. The device trains, using the tokenized chunks, a large language model that includes a co-occurrence attention mechanism to predict maintenance tasks for the monitored system.

### TECHNICAL FIELD

The present disclosure relates generally to training large language models (LLMs) for predictive maintenance.

### BACKGROUND

Today, computer networks are complex systems that interconnect many thousands, or even millions, of nodes across any number of locations and whose complexity is ever-increasing. Indeed, both the networking infrastructure itself (e.g., routers, switches, firewalls, etc.), as well as the endpoints (e.g., servers, end user devices, etc.) may include hardware and software from any number of manufacturers. Even in the case of devices being of the same type and from the same manufacturer, there may be variations in a computer network in terms of which versions of software those devices execute (e.g., firmware, operating system, applications, etc.).

In many computer networks and other such complex systems, it can be quite challenging to determine when to perform maintenance with the ultimate goal of preventing failures. Indeed, log data generated by network devices, systems, and applications typically includes both structured and unstructured text that varies greatly in terms of format and content, depending on its source. Furthermore, log data is typically produced in high volumes, and critical events or anomalies are often buried within repetitive, routine entries.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of the creation of a foundation model;

FIG. 4 illustrates an example of the analysis of log data using an LLM;

FIG. 5 illustrates an example architecture for a data preparation pipeline to train an LLM for predictive maintenance;

FIGS. 6-7 illustrate example schematic diagrams of an LLM trained using the architecture of FIG. 5;

FIG. 8 illustrates an example of using a trained LLM for predictive maintenance; and

FIG. 9 illustrates an example simplified procedure for training an LLM for predictive maintenance.

### DESCRIPTION OF EXAMPLE IMPLEMENTATIONS

### Overview

According to one or more implementations of the disclosure, a device obtains log data from a monitored system. The device processes the log data using a rolling window to form log chunks. The device converts the log chunks into tokenized chunks. The device trains, using the tokenized chunks, a large language model that includes a co-occurrence attention mechanism to predict maintenance tasks for the monitored system.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

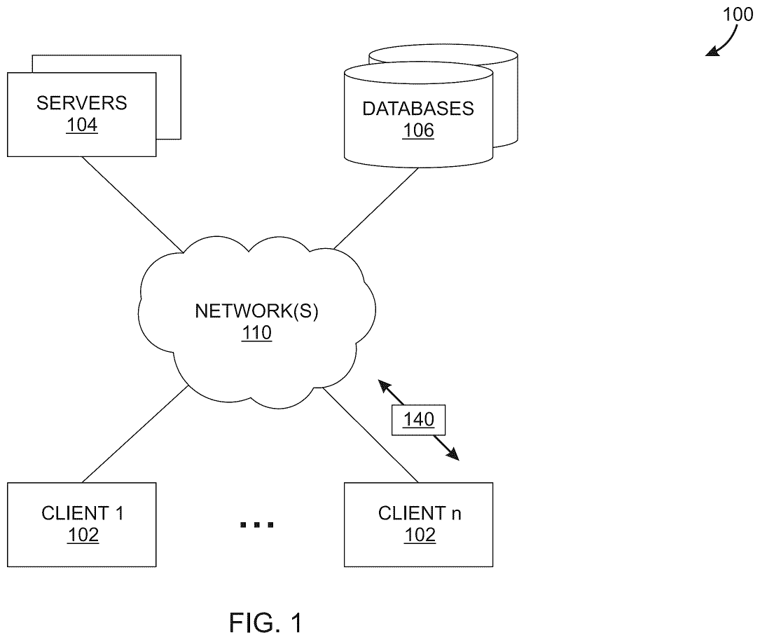

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

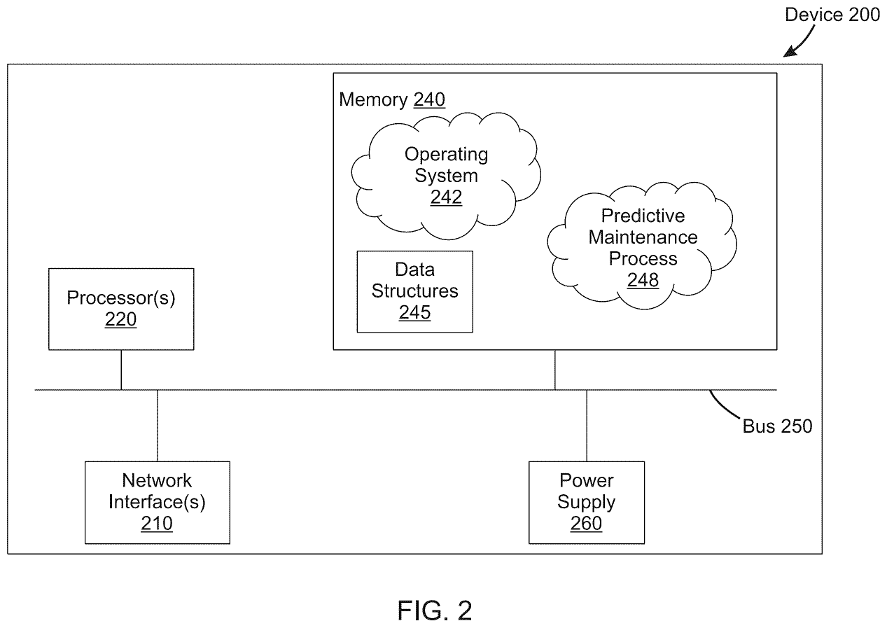

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an illustrative process such as predictive maintenance process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, predictive maintenance process 248 may include computer executable instructions that, when executed by processor 220, cause device 200 to perform the techniques described herein. To do so, in some implementations, predictive maintenance process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, predictive maintenance process 248 may employ one or more supervised, unsupervised, or semi-supervised machine learning models. Generally, supervised learning entails the use of a training set of data that is used to train the model to apply labels to the input data. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data, an example of which are self-supervised models.

Example machine learning techniques that predictive maintenance process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, predictive maintenance process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), foundation models such as large language models (LLMs), other transformer models, and the like.

As noted above, in many computer networks and other such complex systems, it can be quite challenging to determine when to perform maintenance with the ultimate goal of preventing failures. Indeed, log data generated by network devices, systems, and applications typically includes both structured and unstructured text that varies greatly in terms of format and content, depending on its source. Furthermore, log data is typically produced in high volumes, and critical events or anomalies are often buried within repetitive, routine entries.

While it may be possible to implement a rule-based log parser or statistical anomaly detector for purposes of predictive maintenance, such approaches are limited in their ability to scale and generalize across different log types. These approaches also lack the sophisticated contextual understanding necessary to accurately detect subtle, multi-step anomalies or patterns that may indicate system failures or security threats.

Recently, large language models (LLMs) have emerged as powerful tools in the field of natural language processing, offering remarkable capabilities in understanding and generating human-like text. However, their application to more specialized domains such as log analysis and predicting when to perform maintenance present several fundamental challenges. First, the disparate types and formats of the logs from a computer network make it difficult for conventional LLMs to parse and interpret such data effectively without extensive pre-processing. Furthermore, the high variability of log data requires models that can dynamically adapt to changes in format, structure, and event patterns, which traditional LLMs are not well-equipped to handle. Additionally, the computational cost of training and fine-tuning large-scale models on domain-specific datasets, such as logs, is prohibitively high, leading to inefficiencies in deployment and real-time analysis.

### Training LLMs for Predictive Maintenance

According to various implementations, the techniques herein provide a comprehensive system for training LLMs that are optimized for predictive maintenance, combining advanced data preparation techniques, customized model architecture, and computational efficiency. By addressing challenges such as handling unstructured log data, detecting predictive patterns through specialized model design and improving the efficiency of the training process, the system enables the development of highly accurate and scalable LLMs for industrial applications, such as performing predictive maintenance of a computer network. The resulting models improve failure prediction accuracy, reduce downtime, and extend the lifespan of critical equipment, offering substantial economic and operational benefits to industries that rely on predictive maintenance.

Illustratively, the techniques described herein may be performed by hardware, software, and/or firmware, such as in accordance with predictive maintenance process 248, which may include computer executable instructions executed by the processor 220 (or independent processor of interfaces 210) to perform functions relating to the techniques described herein.

Specifically, according to various implementations, a device obtains log data from a monitored system. The device processes the log data using a rolling window to form log chunks. The device converts the log chunks into tokenized chunks. The device trains, using the tokenized chunks, a large language model that includes a co-occurrence attention mechanism to predict maintenance tasks for the monitored system.

Operationally, the techniques herein introduce an approach to data preparation, architectural design, training, and fine-tuning of LLMs from scratch for domain-specific tasks such as log data understanding and predictive maintenance. In various implementations, the system includes three primary mechanisms:
1.) a pre-processing pipeline that extract, normalizes and tokenizes raw log data to make it more informative for large-scale model training;
2.) a modified Transformer-based architecture that incorporates a co-occurrence-based attention mechanism/function, allowing the model to focus on repetitive and critical log entry sequences that often signify anomalies or system events; and
3.) a dynamic fine-tuning process that adjusts model parameters in real-time based on feedback from specific log analysis tasks.

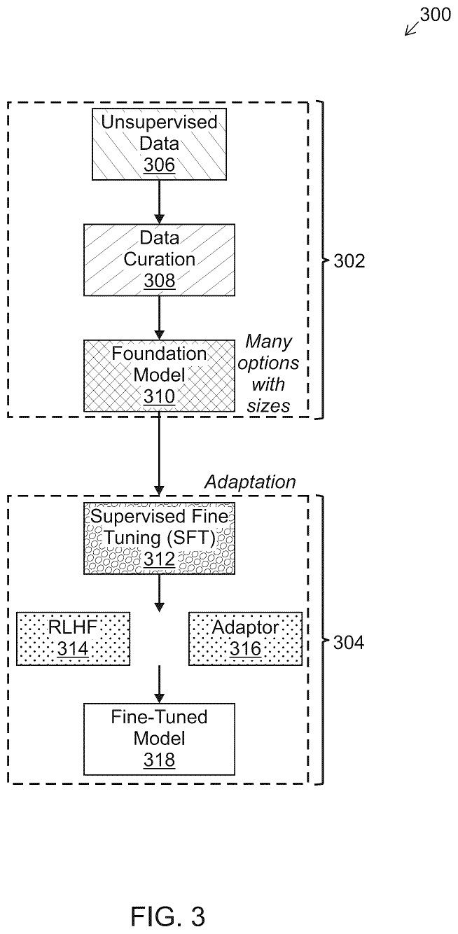

FIG. 3 illustrates an example 300 of the creation of a foundation model, in various implementations. Generally, this approach can be used to train and later adapt a foundation model, such as an LLM. Predictive maintenance process 248 may perform any or all of the actions depicted in FIG. 3, to create an LLM, as described further below. As show, the training of foundation model 310 (e.g., an LLM) may take place in two phases: a first phase 302 in which the base foundation model 310 is trained and a second phase 304 in which foundation model 310 undergoes adaptation to perform specific tasks.

During phase 302, predictive maintenance process 248 may begin with the collection of unsupervised data 306, such as log data from any number of nodes/devices in a computer network or another system of interest. As would be appreciated, unsupervised data 306 may include raw data (e.g., logs, telemetry, etc.) that may be structured and/or unstructured. In turn, predictive maintenance process 248 may perform data curation 308 on unsupervised data 306. This may entail, for instance, organizing unsupervised data 306 in a manner that makes it accessible for purposes of training foundation model 310.

Once unsupervised data 306 has been trained on unsupervised data 306, predictive maintenance process 248 may then enact the second phase 304, which exists to improve the accuracy of foundation model 310, to form fine-tuned model 318. To do so, predictive maintenance process 248 may leverage supervised fine-tuning (SFT) 312, reinforcement learning from human feedback (RLHF) 314, and/or a Low-Rank Adaptation (LoRA)/quantized LoRA((QLoRA) adaptor 316. As would be appreciated, SFT generally entails using a smaller dataset to fine-tune a model using domain-specific information in a supervised manner, to improve its ability to perform certain tasks. RLHF generally entails having one or more human experts provide feedback that is used to (re)train the model (e.g., an indication that a response from the model is correct or incorrect, etc.). LoRA/QLoRA generally operates by freezing model weights and injecting additional, trainable layers.

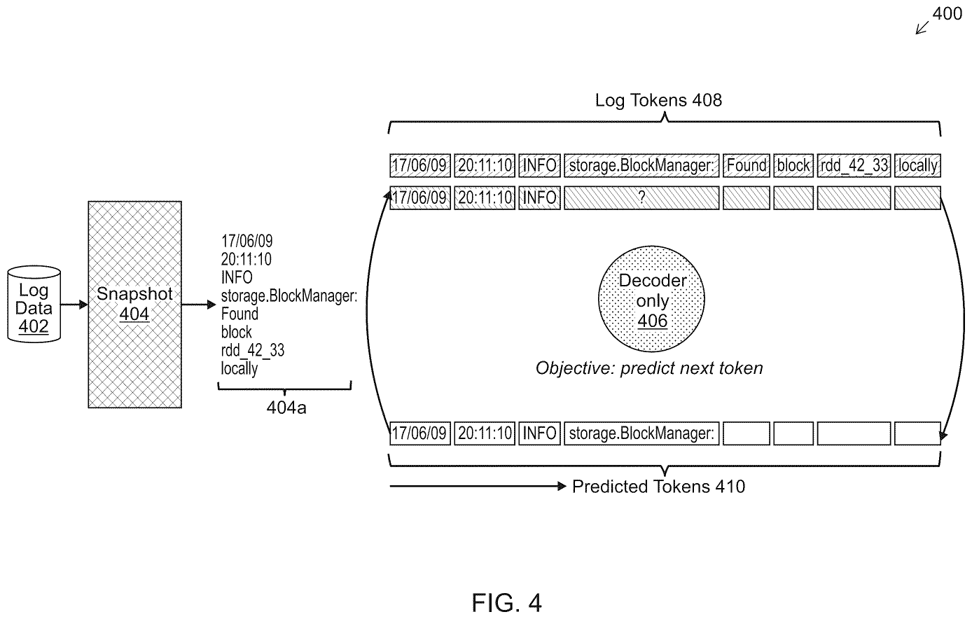

FIG. 4 illustrates an example 400 of the analysis of log data using an LLM, according to various implementations. As shown, the system may take as input log data 402 from one or more nodes/devices and take snapshots 404 from log data 402 for input to the trained LLM. For instance, consider the case of snapshot 404a that reads as follows:
“17/06/09
20:11:10
storage.BlockManager:
Found
block
rdd_42_33
locally.”

In such a case, the LLM may assess the log tokens 408 of snapshot 404a sequentially using its decoder 406, with the goal of predicting the next token. Doing so leads to the LLM generating predicted tokens 410 over time. Note that this is a symbolic representation only. In addition, the choice of the ‘best,’ second best, or third best out of possible words leads to generation of different log messages demonstrating various scenarios.

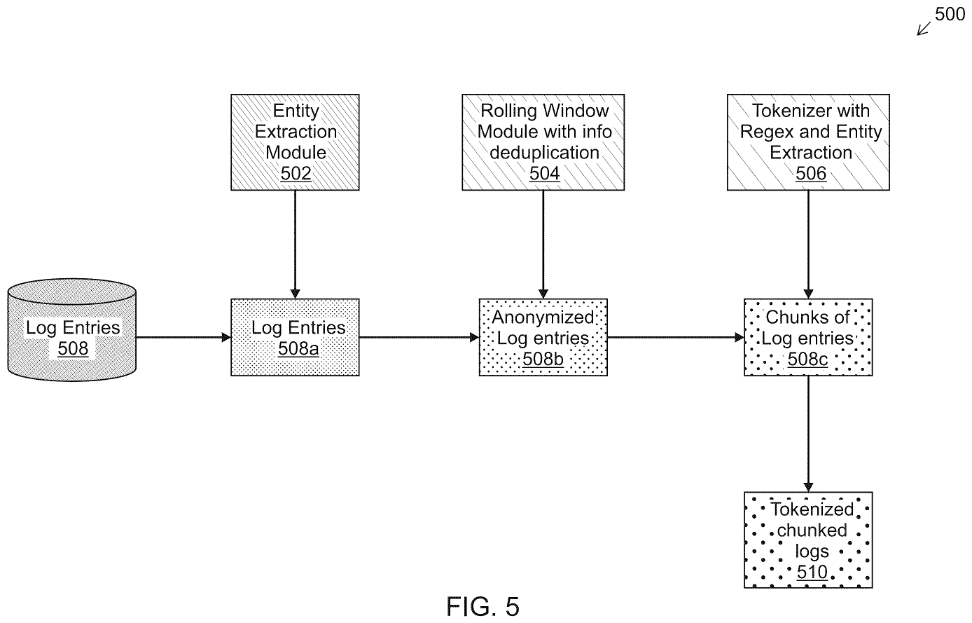

FIG. 5 illustrates an example architecture 500 for a data preparation pipeline to train an LLM for predictive maintenance, in various implementations. For instance, architecture 500 may be used to implement a data preparation pipeline for predictive maintenance process 248. As shown, predictive maintenance process 248 may include any or all of the following components: an entity extraction module 502, a rolling window module 504, and/or a tokenizer 506. The functionalities of these components may be combined or omitted, as desired. In addition, these components may be executed by a singular device or in a distributed manner, in which case the set of executing devices may be viewed as a singular device for purposes of the teachings herein.

In general, the pre-processing pipeline shown handles the highly variable nature of log data by collapsing repetitive entries, normalizing formats, and applying domain-specific tokenization and embedding techniques. This reduces the noise within the data, making it easier for the model to identify important patterns a smaller dataset with high data quality provides cheaper and faster training than a larger dataset with noisy data.

The pre-processing pipeline is designed to address the challenges posed by the structured and/or unstructured and variable nature of log data. It begins with a normalization step during which entity extraction module 502 extracts the log data in log entries 508 into individual log entries 508a. In turn, rolling window module 504 may assess log entries 508a and collapse repetitive entries in log entries 508a and/or convert non-standard formats into a uniform structure, thereby deduplicating the information in individual log entries 508a. Doing so helps to ensure that log entries, regardless of their source, follow a consistent structure, making it easier for the model to process the data.

In some implementations, rolling window module 504 may also anonymize the information within log entries 508a to form anonymized log entries 508b. For instance, in the case of log entries 508 being sourced from one or more nodes/devices in a computer network, rolling window module 504 may replace IP or MAC addresses with anonymized representations. In such cases, the system may still maintain copies of original, compressed log entries and anonymized ones for successive stochastic training. Afterwards, rolling window module 504 may club together chunks of log entries together using a rolling window of log lines based on information available in them, to form chunks of log entries 508c. This allows for filtering commonly occurring log entries that are non-informational and contribute to most of the log traffic.

The next stage involves tokenization, whereby tokenizer 506 breaks down log entries 508c into meaningful units based on regexes and entity extraction while keeping them as singular token, e.g., IP address, timestamp, error codes, etc. The end result of this pipeline is tokenized chunked logs 510 that can be passed through a semantic embedding layer, which maps each token to a high-dimensional vector that captures its contextual meaning within the log entry. This embedding process allows the model to understand the relationships between different tokens, even if they appear in different contexts or formats across log entries.

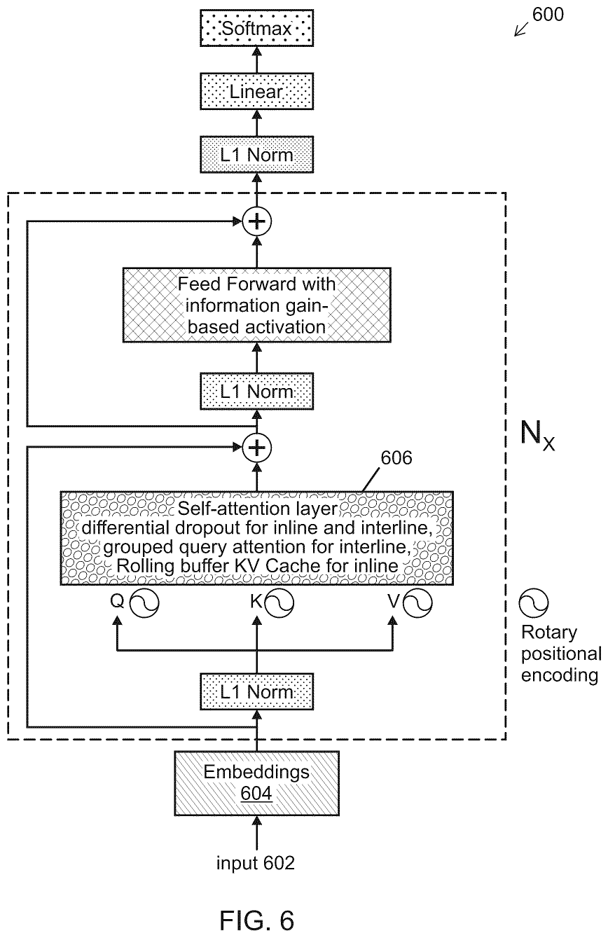

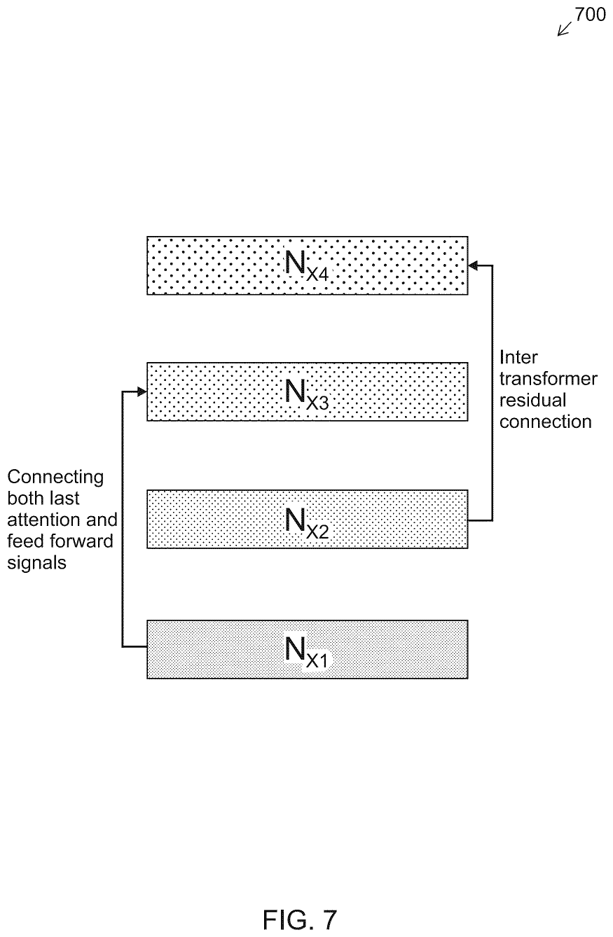

FIGS. 6-7 illustrate example schematic diagrams of an LLM trained using the architecture of FIG. 5, in various implementations. More specifically, FIG. 6 illustrates an example transformer architecture 600 for the LLM. As shown, the core of the model is built on a transformer architecture, which has been modified to better handle the sequential nature of log data. More specifically, given an input dataset 602 (e.g., log data), the system may perform the pre-processing described previously and convert the tokens thereof into embeddings 604 for input to the LLM.

In various implementations, the LLM may include a modified attention mechanism 606 that takes the form of a self-attention layer with differential dropout for inline and interline processing, grouped query attention for interline processing, and a rolling buffer key-value cache for inline processing. FIG. 7 illustrates an example 700 of the co-occurrence-based attention mechanism in greater detail whereby the mechanism connects both the last attention and feed forward signals, as well as inter-transformer residual connections.

The stroboscopic effect and superimposition of multiple events happing in an application or network system emphasize the need of a better regularization over attention which is generally kept low for an LLM like GPTs. Accordingly, the techniques herein enhance this further by alleviating the attention value from cross-log entries in a chunk than within the log line, as they expect the relation between lines is of utmost importance for a phenomenon to evolve. In addition, the techniques herein may leverage information gain-based activation functions in linear layers to capture state space aspects of the data, which may lead to better convergence, but at a higher computational cost. The attention mechanism is so-called “co-occurrence” attention mechanism as it captures cooccurrence of events better.

More specifically, in traditional transformer models, the attention mechanism allows the model to focus on relevant parts of the input data. In contrast, the attention mechanism herein has been enhanced to focus specifically on tokens that frequently co-occur in log data sequences. For example, certain error codes may always appear alongside specific system events or warnings. In doing so, the model gives greater weight to these co-occurrences, allowing it to prioritize and highlight critical patterns within the log data. This mechanism significantly improves the ability of the model to identify anomalies and detect event chains that indicate system failures and hence predict meaningful future logs that emphasize of anomalies, which is a requirement for performing predictive maintenance. Additionally, it incorporates a temporal context layer, allowing the model to learn from long-term data trends, which are important for detecting slow-developing issues.

In some implementations, predictive maintenance process 248 may also leverage a computational framework that optimizes the training process, reducing resource consumption, and improving training speed. For instance, the training may use parallelized processing, gradient accumulation, and/or adaptive batch sizing, which allows the system to efficiently handle large-scale datasets while maintaining accuracy in predicting system failures.

More specifically, to address the issue of high computational cost associated with training large language models, predictive maintenance process 248 may use a computational framework that optimizes model performance while minimizing resource consumption. The system may use parallelized processing techniques to distribute log data across multiple nodes, ensuring rapid data ingestion and analysis. It may also use a gradient accumulation strategy during training, allowing the model to efficiently handle large datasets without overwhelming computational resources. For inference, the system may utilize an adaptive batch size mechanism that adjusts processing loads based on system availability, ensuring that the model can operate in low-latency environments without compromising on accuracy. This optimization framework significantly reduces the cost and time associated with deploying LLMs in industrial environments, making it scalable for enterprise environments with high log generation rates.

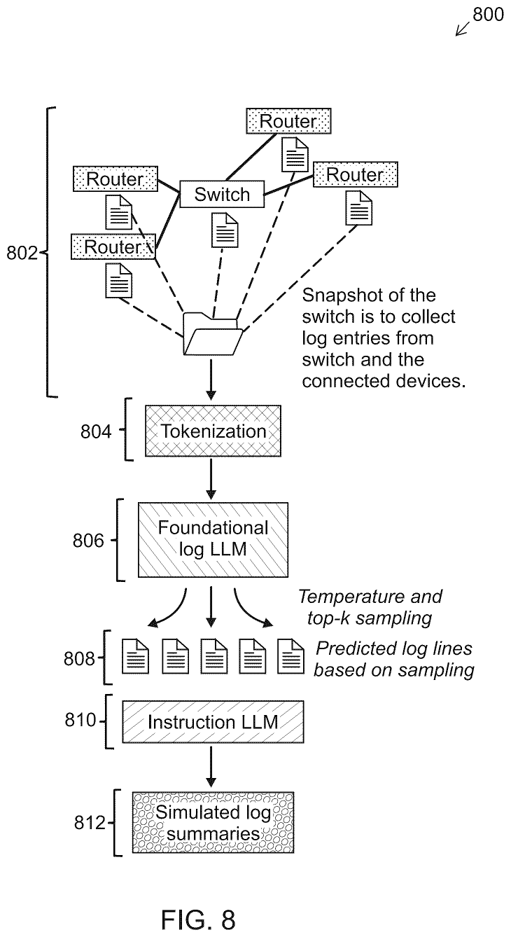

FIG. 8 illustrates an example 800 of using a trained LLM for predictive maintenance, in various implementations. In a real-world application, the system shown could be deployed to monitor and predict failures in a large-scale corporate network. Typically, routers and switches in the network generated millions of log entries daily, including packet loss reports, CPU usage data, and interface error logs. To this end, the system may collect logs 802 from any number of these nodes/devices in the computer network and create snapshots therefrom.

In turn, the system may perform tokenization 804 on the log snapshots and input the resulting tokens into LLM 806, which was trained using the techniques above to assess the log information. LLM 806 may then predict log lines 808 (e.g., tokens) based on the tokens in the snapshot. In some implementations, the system may also leverage an instructional LLM 810 that generates simulated log summaries 812.

As would be appreciated, the system may leverage a co-occurrence-based attention mechanism to learn to recognize sequences that indicated impending router failures. For example, the model may identify that specific error codes paired with sustained high traffic load on a router often preceded hardware failure within 24 hours. The computational framework of the system allows for efficient training on this large dataset, reducing the training time by 35%. Prototyping of the system shown indicates that it was able to predict router failures with a 90% accuracy rate, allowing network administrators to take proactive measures and reduce network downtime by 40%.

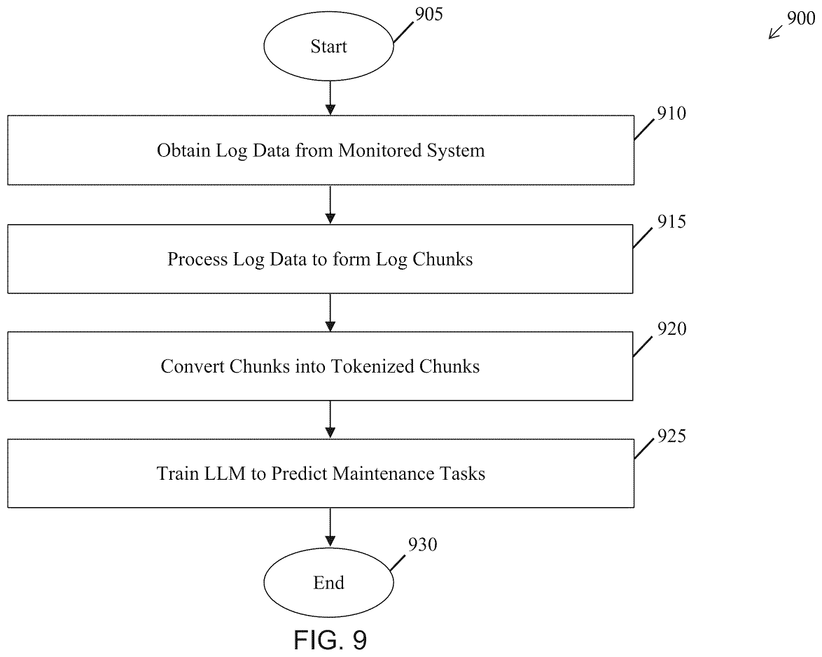

FIG. 9 illustrates an example of a simplified procedure for training an LLM for predictive maintenance, in accordance with one or more implementations described herein. For example, a non-generic, specifically configured device (e.g., device 200), may perform procedure 900 (e.g., a method) by executing stored instructions (e.g., predictive maintenance process 248). The procedure 900 may start at step 905, and continues to step 910, where, as described in greater detail above, the device (e.g., a networking device, a server, etc.) may obtain log data from a monitored system. In various implementations, the monitored system comprises a computer network. In some implementations, the log data comprises unstructured data.

At step 915, as detailed above, process the log data using a rolling window to form log chunks. Such a window may take the form of a certain number of lines of log entries, correspond to a certain time window, or the like.

At step 920, the device may convert the log chunks into tokenized chunks, as described in greater detail above. In some implementations, the device may also anonymize information within the log data, prior to converting the log chunks into tokenized chunks. In various implementations, the device may also deduplicate the log data, prior to forming the log chunks.

At step 925, as detailed above, the device may train, using the tokenized chunks, a large language model that includes a co-occurrence attention mechanism to predict maintenance tasks for the monitored system. In various implementations, the device may deploy the large language model to suggest maintenance tasks regarding the monitored system to a user interface. In some implementations, the co-occurrence attention mechanism prioritizes events indicated by input logs to the large language model that are associated with degraded performance or failures predicted in the monitored system. In various implementations, the maintenance tasks comprise at least one of: replacing a component of the monitored system, applying a software update to that component, or reconfiguring that component. In another implementation, the large language model comprises a temporal context layer. In some implementations, the device may also update the large language model using at least one of: supervised fine tuning, reinforcement learning with human feedback, or a Low-Rank Adaptation (LoRA)-based adaptation.

Procedure 900 then ends at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for training an LLM for predictive maintenance, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, log data from a monitored system;
processing, by the device, the log data using a rolling window to form log chunks;
converting, by the device, the log chunks into tokenized chunks; and
training, by the device and using the tokenized chunks, a large language model that includes a co-occurrence attention mechanism to predict maintenance tasks for the monitored system.

2. The method as in claim 1, further comprising:
deploying the large language model to suggest maintenance tasks regarding the monitored system to a user interface.

3. The method as in claim 1, wherein the monitored system comprises a computer network.

4. The method as in claim 1, wherein the log data comprises unstructured data.

5. The method as in claim 1, wherein the co-occurrence attention mechanism prioritizes events indicated by input logs to the large language model that are associated with degraded performance or failures predicted in the monitored system.

6. The method as in claim 1, further comprising:
anonymizing information within the log data, prior to converting the log chunks into tokenized chunks.

7. The method as in claim 1, wherein the maintenance tasks comprise at least one of: replacing a component of the monitored system, applying a software update to that component, or reconfiguring that component.

8. The method as in claim 1, wherein the large language model comprises a temporal context layer.

9. The method as in claim 1, further comprising:
deduplicating the log data, prior to forming the log chunks.

10. The method as in claim 1, further comprising:
updating the large language model using at least one of: supervised fine tuning, reinforcement learning with human feedback, or a Low-Rank Adaptation (LoRA)-based adaptation.

11. An apparatus, comprising:
one or more network interfaces;
a processor coupled to the one or more network interfaces and configured to execute one or more processes; and
a memory configured to store a process that is executable by the processor, the process when executed configured to:
obtain log data from a monitored system;
process the log data using a rolling window to form log chunks;
convert the log chunks into tokenized chunks; and
train, using the tokenized chunks, a large language model that includes a co-occurrence attention mechanism to predict maintenance tasks for the monitored system.

12. The apparatus as in claim 11, wherein the process when executed is further configured to:
deploy the large language model to suggest maintenance tasks regarding the monitored system to a user interface.

13. The apparatus as in claim 11, wherein the monitored system comprises a computer network.

14. The apparatus as in claim 11, wherein the log data comprises unstructured data.

15. The apparatus as in claim 11, wherein the co-occurrence attention mechanism prioritizes events indicated by input logs to the large language model that are associated with degraded performance or failures predicted in the monitored system.

16. The apparatus as in claim 11, wherein the process when executed is further configured to:
anonymize information within the log data, prior to converting the log chunks into tokenized chunks.

17. The apparatus as in claim 11, wherein the maintenance tasks comprise at least one of: replacing a component of the monitored system, applying a software update to that component, or reconfiguring that component.

18. The apparatus as in claim 11, wherein the large language model comprises a temporal context layer.

19. The apparatus as in claim 11, wherein the process when executed is further configured to:
deduplicate the log data, prior to forming the log chunks.

20. A tangible, non-transitory, computer-readable medium storing program instructions that cause a device to execute a process comprising:
obtaining, by the device, log data from a monitored system;
processing, by the device, the log data using a rolling window to form log chunks;
converting, by the device, the log chunks into tokenized chunks; and
training, by the device and using the tokenized chunks, a large language model that includes a co-occurrence attention mechanism to predict maintenance tasks for the monitored system.
